(19) United States
(12) Patent Application Publication
(10) Pub. No.: US 2009/0126245 A1
(43) Pub. Date: May 21, 2009

(54) Garment divider

(76) Inventors: Nancy M. Currin, Blacksburg, VA (US); Amelia O. Dickinson, Ponte Vedra, FL (US)

Correspondence Address: RICHARD L HUFF, 19304 OLNEY MILL ROAD, OLNEY, MD, 20832, US

(21) Appl. No.: 12/291,368

(22) Filed: Nov. 10, 2008

Related U.S. Application Data
(60) Provisional application No. 61/003,437, filed on Nov. 16, 2007.

(51) Int. Cl. G09F 3/18

(52) U.S. Cl. 40/673

(57) ABSTRACT

A divider for garments on a clothes rack. The divider is easily fit onto the clothes rack in a desired location and a laterally extending part is prominently displayed. The laterally extending part contains information as to the adjacent articles of clothing contained on at least one side of the divider. The divider may be used in home closets to separate different types of clothing or it may be used in stores to separate different sizes of the same type of clothing.

### CROSS-REFERENCE TO RELATED APPLICATIONS

This application claims the benefit of the filing date of provisional application 61/003,437 filed Nov. 16, 2007.

### STATEMENT REGARDING FEDERALLY SPONSORED RESEARCH OR DEVELOPMENT

(Not applicable)

### REFERENCE TO SEQUENTIAL LISTING, A TABLE, OR A COMPUTER PROGRAM LISTING APPENDIX SUBMITTED ON A COMPACT DISC

(Not applicable)

### BACKGROUND OF THE INVENTION

1) Field of the Invention

This invention pertains to devices which fit on clothes racks and separate different articles of clothing. The devices may be used in home closets to separate different types of clothing or may be used on clothing racks in stores to separate different sizes of the same type of clothing.

2) Description of the Related Art

Other clothing separators are known in patent literature and in commerce. These devices separate clothing on racks in a satisfactory manner and one skilled in the art would not recognize any need for improvement.

### BRIEF SUMMARY OF THE INVENTION

The invented device may conveniently be made of wood or plastic and may be color coded or have the desired information displayed on it in any conventional manner. The device is adapted to easily fit over clothes rods and racks and may easily slide along the rod or rack as the situation demands. The device has a prominent laterally extending part which improves the visibility of the device and provides space for information as to adjacent clothing.

### BRIEF DESCRIPTION OF THE SEVERAL VIEWS OF THE DRAWINGS

FIG. 1 is an elevational perspective view of the first embodiment of the present invention wherein there is a channel between the side of the device and the hollow area which fits over the clothes rack.

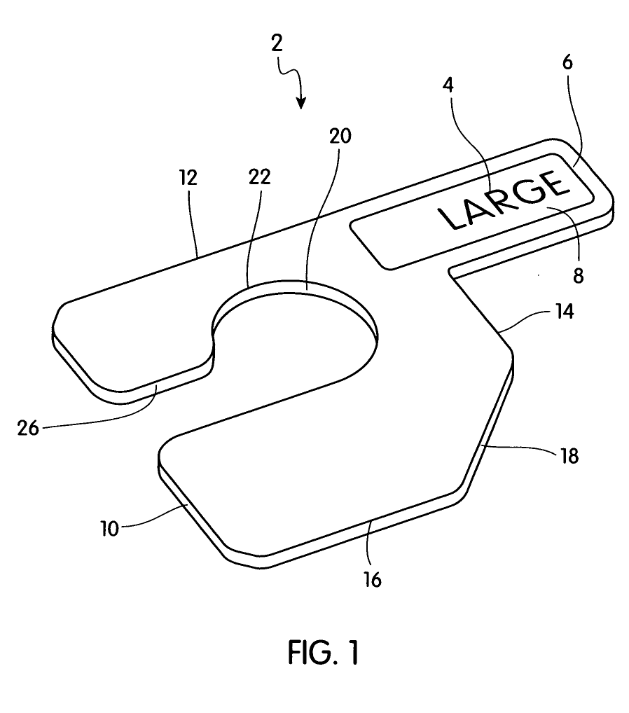

FIG. 2 is an elevational perspective view of the second embodiment of the present invention wherein there is a slit which allows the device to be twisted to create an opening of sufficient size as to allow the device to be fitted over a clothes rack.

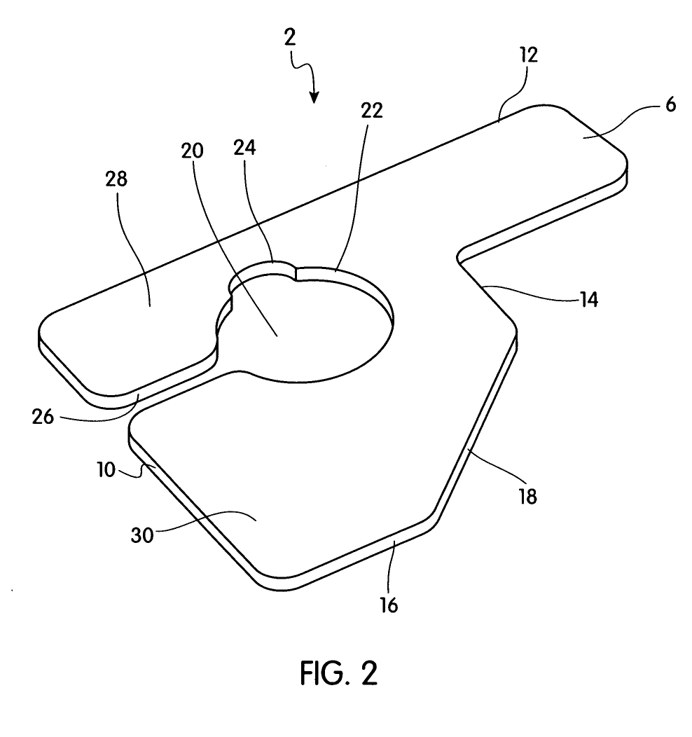

### DETAILED DESCRIPTION OF THE INVENTION

The present invention is directed to a garment divider 2 for use on clothes rods or racks. For convenience, the term rack will be used to signify any rod, rack, or other structure which conventionally holds a series of clothes hangers. The racks may be in closets and the device 2 may separate different types of clothes, such as skirts and blouses. Also, the racks may be in stores and the device 2 may separate different sizes of the same type of clothing, such as small and medium articles. Thus, the racks may have different sizes. The devices 2 may be prepared from wood or plastic. The devices 2 may be color coded or may contain the desired information 4 visually or tactilely on a prominent laterally extending part 6. A convenient way of imparting the desired information 4 to the device 2 is by applying a label 8 which has a backing having low adhesion so that the label 8 may be easily applied and removed.

The device 2 contains a first side, 10 a top side, 12 a second side, 14 a bottom side 16 connected to the second side 14 by a diagonal side, 18 and a prominent laterally extending part 6 being an extension of the top side 12 from the second side 14. The device 2 contains a hollow area 20 of such a size as to fit over a clothes rack. To accommodate different sizes of racks the hollow area 20 has a large upper arc 22 having a smaller arc 24 on top of it. Thus the smaller arc 24 will fit over and rest on smaller racks while the larger arc 22 will fit over and rest on larger racks. This allows the same device 2 to be used with a plurality of differently sized racks. The hollow area 20 is connected to the first side 10 by a channel 26 which is, or is made to be, of sufficient size as to fit over the clothes rack.

In a first embodiment the device 2 is prepared from wood or stiff plastic. There is a broad channel 26 connecting the hollow area 20 with the first side 10. The broad channel 26 is sufficiently broad to allow the device 2 to be loosely fitted over the rack.

In use, the device 2 is fitted onto a clothes rack in a desired location by slipping the channel 26 over the clothes rack, the device 2 coming to rest on the clothes rack when the hollow area 20 encompasses the clothes rack.

In a second embodiment the device 2 is prepared from pliable plastic. There is a narrow slit 26 connecting the first side 10 and the hollow area 20.

In use, the device 2 is twisted in such a known way as to separate the first side 10 into an upper part 28 above the slit 26 and a lower part 30 below the slit 26. The separation is in a direction normal to the plane of the device 2 so as to cause an opening between the upper 28 and lower 30 parts large enough to slip over the clothes rack. This opening is slipped over the clothes rack in a desirable location, the device 2 coming to rest on the clothes rack when the hollow area 20 encompasses the clothes rack.

The laterally extending part 6 is prominent and can be easily seen or felt by the customer or home owner user. The laterally extending part 6 contains information 4 which identifies the adjacent clothes on one side of the device 2 by means of color coding, visible pictures, symbols, alphanumerals, or Braille. The information 4 may be preprinted on the laterally extending part 6 but the most preferred method of incorporating information 4 is to apply the information 4 to a label 8 having low adhesive properties and applying the label 8 to one side of the prominent laterally extending part 6. If desired, a second label (not shown) may be applied to the opposite side (not shown) of the laterally extending part 6, allowing the device 2 to give information as to clothes on both sides of the device 2.

The prominent laterally extending part 6 is maintained in a lateral position and does not fall downwardly or tilt upwardly. This feature is due to the fact that the material between the first 10 and second 14 sides is of such a mass as to serve as a counterweight which provides a center of gravity in such a location as to keep the laterally extending part 6 pointing outward in a horizontal direction. Devices 2 shown in the Figures are of such a size and shape as to have this property. Devices of other sizes and shapes can be made to have this property by methods known to the art.

Although the invention has been described and illustrated in detail, it is to be clearly understood that the same is by way of illustration and example, and is not to be taken by way of limitation. The spirit and scope of the present invention are to be limited only by the terms of the appended claims.

1. A device which is adapted to fit on a clothes rack and separate different articles of clothing, which device contains a prominent laterally extending part containing information as to adjacent clothing.

2. The device of claim 1, wherein the prominent laterally extending part is color coded or contains visual or tactile information pertaining to the clothes on at least one side of the device.

3. The device of claim 2, wherein the visual or tactile information is incorporated on a label which may be easily applied and removed.

4. The device of claim 1, which contains a hollow area allowing the device to fit on the clothes rack.

5. The device of claim 4, wherein the hollow area has a large upper arc having a smaller arc on top of the large arc, thus permitting use of the device with different sized racks.

6. The device of claim 5, wherein the device contains a first side, a top side, a second side, a bottom side connected to the second side by a diagonal side, and the laterally extending part being an extension of the top side from the second side.

7. The device of claim 6, wherein the material between the first and second sides is of such a mass as to provide a center of gravity in such a location as to keep the laterally extending part pointing outward in a horizontal direction.

8. The device of claim 7 which contains a broad channel connecting the first side and the hollow area, which channel is of sufficient size as to fit over the clothes rack.

9. The device of claim 7, which contains a narrow slit connecting the first side and the hollow area, the device being capable of being twisted so as to enlarge the slit to such a size as to be able to slip over the clothes rack.
